(19) United States
(12) Patent Application Publication
(10) Pub. No.: US 2009/0015576 A1
(43) Pub. Date: Jan. 15, 2009

(54) Flat display and method for driving the same

(75) Inventor: Yu-Tsung Hu, Sihu Township (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., HsinChu (TW)

(21) Appl. No.: 11/987,614

(22) Filed: Dec. 3, 2007

(30) Foreign Application Priority Data
Jul. 13, 2007 (TW) 096125538

(51) Int. Cl. G09G 5/00; G09G 3/34

(52) U.S. Cl. 345/211; 345/84

(57) ABSTRACT

A method for driving a flat display having multiple pixels is provided. Firstly, whether a display mode of the flat display is a normal mode or an impulse-driving mode is determined according to a control signal. Next, the pixels are driven according to a data signal and a first set of reference voltages when the display mode is the normal mode, such that the relationship between the gray level and the light intensity of the pixels is a first gamma curve. Afterwards, the pixels are driven according to the data signal and a second set of reference voltages when the display mode is the impulse-driving mode, such that the relationship between the gray level and the light intensity of the pixels is a second gamma curve, and a second normalization curve is close to a first normalization curve.

This application claims the benefit of Taiwan application Serial No. 96125538, filed Jul. 13, 2007, the subject matter of which is incorporated herein by reference.

### BACKGROUND OF THE INVENTION

1. Field of the Invention

The invention relates in general to a flat display and a method for driving the same, and more particularly to a flat display capable of repairing color distortion and improving the overall light intensity of the pixels with an impulse driving method and a method for driving the same.

2. Description of the Related Art

The problem of motion blur caused by the hold type driving method has been an imminent issue to be resolved for the manufacturers of liquid crystal display. The impulse driving method is a solution adopted in recent years. The impulse driving method effectively reduces the time that the image of the previous frame period stays in the viewer's eye by periodically inserting a black frame into each frame period of the motion picture. However, due to the slow response of liquid crystal molecules and the shortened transmittance time, the liquid crystal display which adopts impulse driving method will cause image color distortion and reduce the overall light intensity of the pixels, hence decreasing the practicality.

Referring to FIG. 1A, an example of ideal relationship diagram of the light intensity of the pixels of a conventional liquid crystal display adopting impulse driving method vs. time is shown. As the impulse driving method is adopted in FIG. 1A, the outputted light intensity of each pixel is pulse-like. The light intensity of each pixel already reaches stability within one frame period, and the light intensity of each pixel will be re-set as “0” or a lower level before the next frame period, so that a black frame can be inserted into.

However, the impulse driving method will result in slow response of the liquid crystal molecules and a shortened light transmittance time. Referring to FIG. 1B, an example of actual relationship diagram of the light intensity of the pixels of a conventional liquid crystal display adopting impulse driving method vs. time is shown. As indicated in FIG. 1B, the light intensity of each pixel is reset as “0” or a lower level for a black frame to be inserted into before the light intensity of each pixel has reached stability within one frame period. Despite the light intensity of the pixels still has the effect of impulse output, however, the color saturation is distorted and the light intensity is largely decreased.

Referring to FIG. 2, a gamma curve of a conventional liquid crystal display adopting impulse driving method is shown. The liquid crystal display substantially displays the image frame by driving the pixels according to the reference voltage (a₀˜a₂₅₅). The gamma curve 201 is an ideal gamma curve of the liquid crystal display not adopting the impulse driving method, and the gamma curve 202 is an actual gamma curve of the liquid crystal display adopting the impulse driving method. According to the gamma curve 201 and the gamma curve 202, after the liquid crystal display adopts the impulse driving method, not only will the light intensity corresponding to each pixel gray level largely be decayed but the trend of the gamma curve 202 corresponding to the decayed ideal gamma curve 203 with the same light intensity will also be largely distorted. As a result, the light intensity of the image frame is too weak and the gray level of the image frame is incorrect, hence deteriorating the practicality of the ultimate image frame.

### SUMMARY OF THE INVENTION

The invention is directed to a flat display and a method for driving the same. The color distortion generated when the flat display is in an impulse-driving mode is repaired by changing the reference voltages or adjusting the data such that the overall light intensity of the pixels is improved.

According to a first aspect of the present invention, a flat display comprising a pixel array, a data driving unit and a reference voltage control unit is provided. The pixel array has multiple pixels. The data driving unit is for driving multiple pixels. The reference voltage control unit comprises a first reference voltage generator, a second reference voltage generator and a first selection unit. The first reference voltage generator is for providing a first set of reference voltages. The second reference voltage generator is for providing a second set of reference voltages. The first selection unit is for outputting the first set of reference voltages or the second set of reference voltages to the data driving unit according to a control signal. When the display mode of the flat display is a normal mode, the first selection unit outputs the first set of reference voltages to the data driving unit, and the data driving unit drives the pixels according to a data signal and the first set of reference voltages, such that the relationship between the gray level and the light intensity of the pixels is a first gamma curve. When the display mode of the flat display is an impulse-driving mode, the first selection unit outputs the second set of reference voltages to the data driving unit, and the data driving unit drives the pixels according to the data signal and the second set of reference voltages, such that the relationship between the gray level and the light intensity of the pixels is a second gamma curve, and a second normalization curve that the second gamma curve is normalized to is close to a first normalization curve that the first gamma curve is normalized to.

According to a second aspect of the present invention, a flat display comprising a pixel array, a data driving unit and a timing generator is provided. The pixel array has multiple pixels. The data driving unit is for driving multiple pixels. The timing generator comprises a first data converter, a second data converter and a first selection unit. The first data converter is for converting an input data signal into a first data signal. The second data converter is for converting the input data signal into a second data signal. The first selection unit is for outputting the first data signal or the second data signal to the data driving unit according to a control signal. When the display mode of the flat display is a normal mode, the first selection unit outputs the first data signal to the data driving unit, and the data driving unit drives the pixels according to the first data signal and reference voltages, such that the relationship between the gray level and the light intensity of the pixels is a first gamma curve. When the display mode of the flat display is an impulse-driving mode, the first selection unit outputs the second data signal to the data driving unit, and the data driving unit drives the pixels according to the second data signal and the reference voltages, such that the relationship between the gray level and the light intensity of the pixels is a second gamma curve, and a second normalization curve that the second gamma curve is normalized to is close to a first normalization curve that the first gamma curve is normalized to.

According to a third aspect of the present invention, a method for driving a flat display having multiple pixels is provided. The method includes the following steps. Firstly, whether a display mode of the flat display is a normal mode or an impulse-driving mode is determined according to a control signal. Next, the pixels are driven according to a data signal and a first set of reference voltages when the display mode is the normal mode, such that the relationship between the gray level and the light intensity of the pixels is a first gamma curve. Afterwards, the pixels are driven according to the data signal and a second set of reference voltages when the display mode is the impulse-driving mode, such that the relationship between the gray level and the light intensity of the pixels is a second gamma curve, and a second normalization curve that the second gamma curve is normalized to is close to a first normalization curve that the first gamma curve is normalized to.

According to a fourth aspect of the present invention, a method for driving a flat display having multiple pixels is provided. The method includes the following steps. Firstly, whether a display mode of the flat display is a normal mode or an impulse-driving mode is determined according to a control signal. Next, an input data signal is converted into a first data signal, and the input data signal is converted into a second data signal. Then, when the display mode of the flat display is the normal mode, the pixels are driven according to the first data signal and a set of reference voltages, such that the relationship between the gray level and the light intensity of the pixels is a first gamma curve. Afterwards, when the display mode of the flat display is the impulse-driving mode, the pixels are driven according to the second data signal and the reference voltages, such that the relationship between the gray level and the light intensity of the pixels is a second gamma curve, and a second normalization curve that the second gamma curve is normalized to is close to a first normalization curve that the first gamma curve is normalized to.

According to a fifth aspect of the present invention, a flat display comprising a pixel array, a data driving unit and an impulse-driving reference voltage generator is provided. The pixel array has multiple pixels. The data driving unit is for driving multiple pixels. The impulse-driving reference voltage generator is for providing a set of impulse-driving reference voltages. When the display mode of the flat display is an impulse-driving mode, the data driving unit drives the pixels according to an impulse-driving data signal and the set of impulse-driving reference voltages, such that the relationship between the gray level and the light intensity of the pixels is a first gamma curve, and a first normalization curve that the first gamma curve is normalized to is close to a target normalization curve that a target gamma curve is normalized to.

According to a sixth aspect of the present invention, a flat display comprising a pixel array, a data driving unit and a timing generator is provided. The pixel array has multiple pixels. The data driving unit is for driving multiple pixels. The timing generator comprises an impulse-driving data converter for converting an input data signal into an impulse-driving data signal. When the display mode of the flat display is an impulse-driving mode, the timing generator outputs the impulse-driving data signal to the data driving unit, and the data driving unit drives the pixels according to the impulse-driving data signal and a set of impulse-driving reference voltages, such that the relationship between the gray level and the light intensity of the pixels is a first gamma curve, and a first normalization curve that the first gamma curve is normalized to is close to a target normalization curve that a target gamma curve is normalized to.

The invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is an example of ideal relationship diagram of the light intensity of the pixels of a conventional liquid crystal display adopting impulse driving method vs. time;

FIG. 1B (Prior Art) is an example of actual relationship diagram of the light intensity of the pixels of a conventional liquid crystal display adopting impulse driving method vs. time;

FIG. 2 (Prior Art) is a gamma curve of a conventional liquid crystal display adopting impulse driving method;

FIG. 3 is a perspective of a flat display according to a preferred embodiment of the invention;

FIG. 4 is a normalization curve of the flat display 300 according to a preferred embodiment of the invention;

FIG. 5 is a perspective of an example of correcting the pixel reference voltage of the flat display 300 in a normally white mode under according to a preferred embodiment of the invention; and

FIG. 6 is a flowchart of a method for driving a flat display according to a preferred embodiment of the invention.

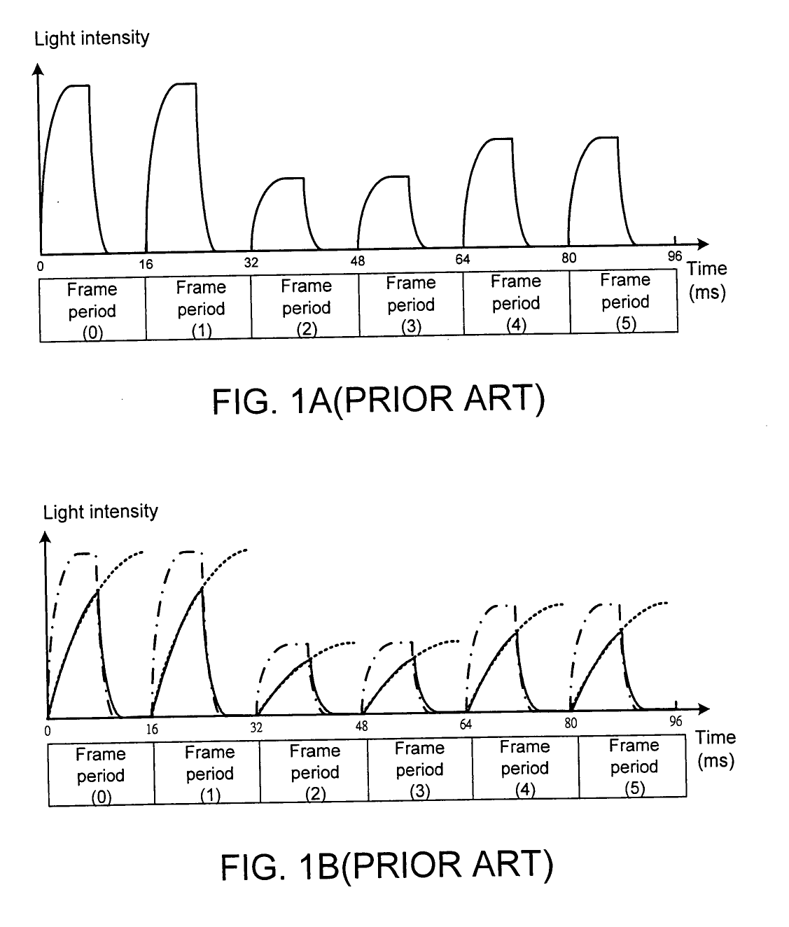

### DETAILED DESCRIPTION OF THE INVENTION

A flat display and a method for driving the same are provided for changing the reference voltages of the pixel when writing data and fine adjusting the written data for repairing the color distortion generated by the flat display in an impulse-driving mode, such that the overall light intensity of the pixels is improved.

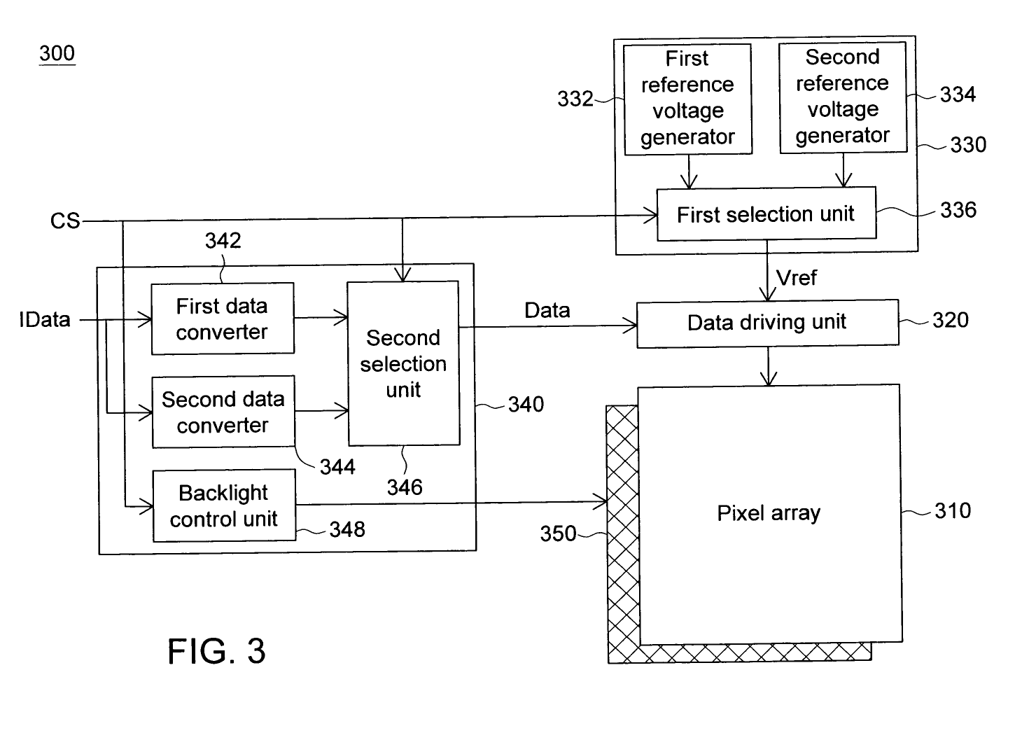

Referring to FIG. 3, a perspective of a flat display according to a preferred embodiment of the invention is shown. The flat display 300, exemplified by a liquid crystal display, comprises a pixel array 310, a data driving unit 320, a reference voltage control unit 330, a timing generator 340 and a backlight module 350. The pixel array 310 is positioned on a panel and has multiple pixels (not illustrated in the diagram). The data driving unit 320 substantially comprises multiple data drivers. The data driving unit 320 drives the multiple pixels of the pixel array 310 to display an image frame according to a set of reference voltages Vref received from the reference voltage control unit 330 and a data signal Data received from the timing generator 340.

The reference voltage control unit 330 comprises a first reference voltage generator 332, a second reference voltage generator 334 and a first selection unit 336. The first reference voltage generator 332 substantially is constituted by a first set of reference resistors for providing a first set of reference voltages, wherein the first set of reference voltages comprises multiple first reference voltages respectively corresponding to 256 gray levels. The second reference voltage generator 334 substantially is constituted by a second set of reference resistors for providing a second set of reference voltages, wherein the second set of reference voltages comprises multiple second reference voltages respectively corresponding to 256 gray levels. The first set of reference resistors and the second set of reference resistors can also be constituted by a semi-conductor circuit. The second reference voltages are obtained by adding corresponding offset voltages to the first reference voltages respectively. The first selection unit 336, exemplified by a multiplexer, determines whether to output the first set of reference voltages or the second set of reference voltages as the reference voltages Vref to the data driving unit 320 according to the control signal CS.

When the control signal CS controls the display mode of the flat display 300 to be a normal mode, the first selection unit 336 will output the first set of reference voltages as the reference voltages Vref to the data driving unit 320 according to the control signal CS, and the data driving unit 320 drives multiple pixels of the pixel array 310 according to the data signal Data received from the timing generator 340 and the reference voltages Vref, such that the relationship between the gray level of the pixels and the light intensity is a first gamma curve.

Besides, when the control signal CS controls the display mode of the flat display 300 to be an impulse-driving mode, the first selection unit 336 will output the second set of reference voltages as the reference voltages Vref to the data driving unit 320 according to the control signal CS, and the data driving unit 320 drives multiple pixels of the pixel array 310 according to the data signal Data received from the timing generator 340 and the reference voltages Vref, such that the relationship between the gray level and the light intensity of the pixels is a second gamma curve, and a second normalization curve that the second gamma curve is normalized to is close to a first normalization curve that the first gamma curve is normalized to.

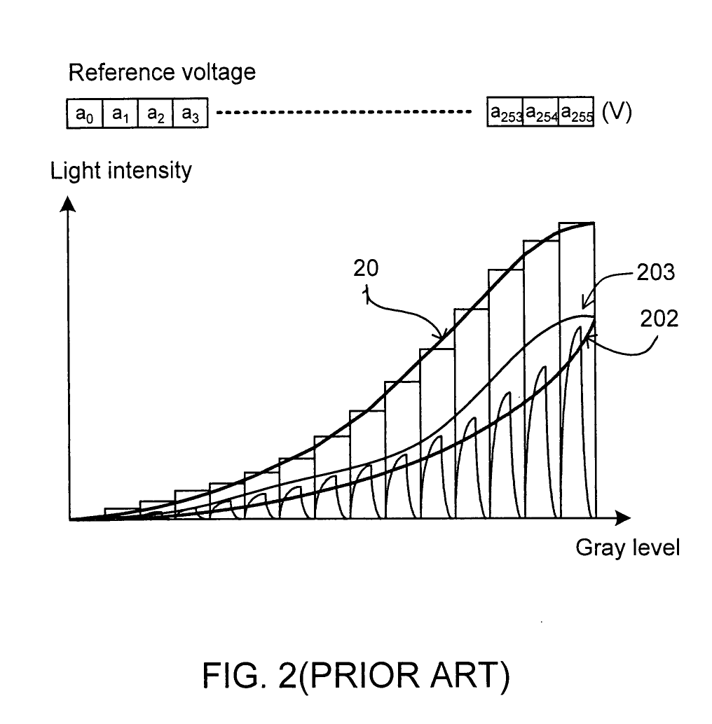

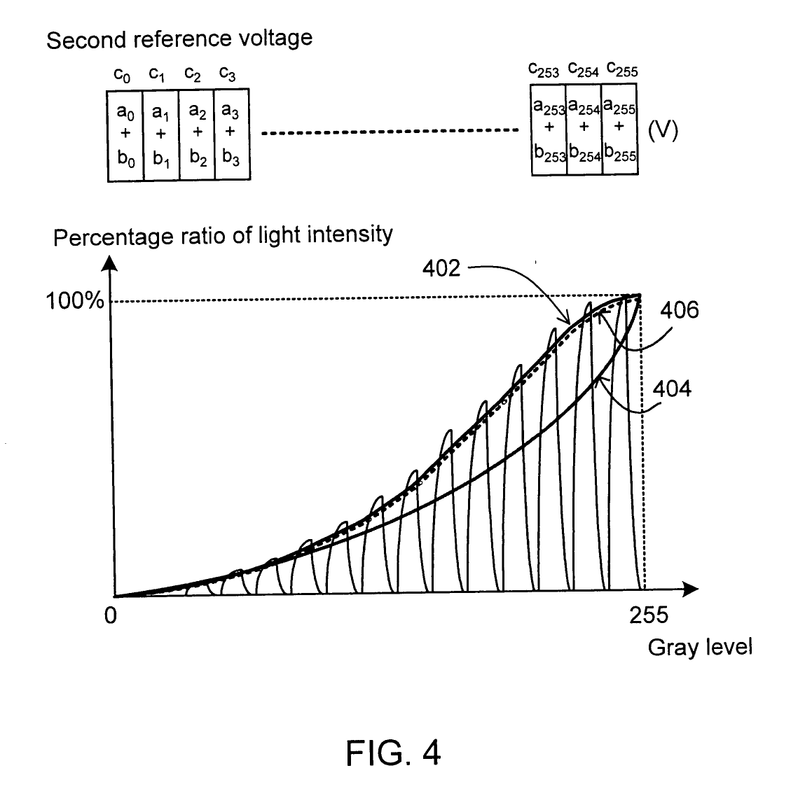

Referring to both FIG. 2 and FIG. 4. FIG. 4 is a normalization curve of the flat display 300 according to a preferred embodiment of the invention. When the liquid crystal display 300 is in an impulse-driving mode, the liquid crystal display 300 displays an image frame by driving the pixels according to multiple second reference voltages (c₀˜c₂₅₅). The second reference voltages are obtained by adding corresponding offset voltages (b₀˜b₂₅₅) to the first reference voltages (a₀˜a₂₅₅), wherein the offset voltages are positive, negative or 0. The gamma curve 201 substantially is the first gamma curve, and the first gamma curve is normalized to a first normalization curve 402. In the normal mode, the flat display 300 drives the pixels according to the first set of reference voltages, such that the relationship between the gray level and the light intensity of the pixels is the first gamma curve. In the impulse-driving mode, if the flat display 300 still drives the pixels according to the first set of reference voltages, then the relationship between the gray level and the light intensity of the pixels will be a gamma curve 202, the light intensity of each gray level pixel will be largely decayed, and the color of the frame will be distorted.

The gamma curve 202 is normalized to a deviated normalization curve 404. To avoid the color of the frame of the flat display 300 being distorted, the deviated normalization curve 404 needs to be adjusted as a second normalization curve 406, wherein the second normalization curve 406 is close to the first normalization curve 402. To adjust the deviated normalization curve 404 as a second normalization curve 406, the pixels are driven by multiple second reference voltages (c₀˜c₂₅₅), such that the relationship between the gray level and the light intensity of the pixels is a second gamma curve 203. The second reference voltages are obtained by adding corresponding offset voltages (b₀˜b₂₅₅) to the first reference voltages (a₀˜a₂₅₅). The offset voltages (b₀˜b₂₅₅) actually enables the distribution of the second gamma curve 203 to be similar to that of the first gamma curve 201, thereby repairing the color distortion of the image frame.

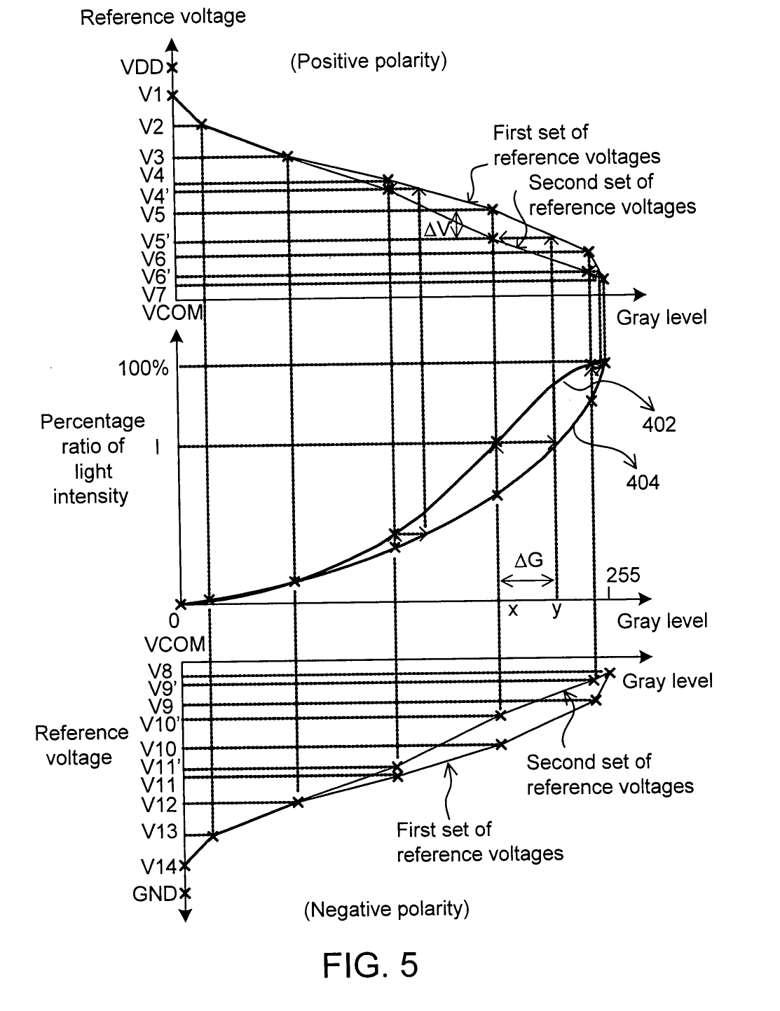

Referring to FIG. 5, a perspective of an example of correcting the pixel reference voltage of the flat display 300 in a normally white mode according to a preferred embodiment of the invention is shown. The driving method of the invention is also applicable to the flat display 300 in a normally black mode, and is not limited thereto. For example, as indicated in FIG. 5, the second normalization curve 404 does not reach the percentage ratio of the light intensity l, which the first normalization curve 402 reaches at the gray level x, until at the gray level y. That is, according to the first set of reference voltages, the corresponding percentage ratio of the light intensity of the gray level corresponding to the reference voltage v5′ when the flat display 300 is in the impulse-driving mode is the same with the corresponding percentage ratio of the light intensity of the gray level corresponding to the reference voltage v5 when the flat display 300 is in the normal mode. The difference between the reference voltage v5 and the reference voltage v5′ is ΔV, that is, the offset voltage corresponding to the gray level x.

The offset voltage corresponding to each gray level can be obtained according to the above principle, and the first set of reference voltages can be corrected as the second set of reference voltages accordingly. By the way, the offset voltages of a few gray levels may be obtained first, and then the overall offset voltages are obtained according to an interpolation method digitally, thereby adjusting external reference voltages to obtain the second set of reference voltages. When the flat display 300 drives multiple pixels of array 310 according to the second set of reference voltages, the relationship between the gray level and the light intensity of the pixels is the second gamma curve 203, and the second normalization curve 406 that the second gamma curve 203 is normalized to is close to the first normalization curve 402. As the distribution of the second gamma curve 203 is already adjusted to be similar to that of the first gamma curve 201, the image color distortion of the flat display 300 in the impulse-driving mode will be repaired. Furthermore, as the light intensities corresponding to the middle gray levels are compensated, the overall light intensity is certainly improved.

Besides, with respect to the same data signal Data, for the overall light intensity of the flat display 300 in the impulse-driving mode pixel to be compensated to be close to the overall light intensity of the flat display 300 in the normal mode pixel, the backlight intensity may be adjusted such that the maximum gray level (255) corresponds to the same light intensity both in the impulse-driving mode and in the normal mode. In the flat display 300, by using the backlight control unit 348 of the timing generator 340 to control the light intensity of the backlight module 350, the light intensity corresponding to the gray level (255) of the flat display 300 in the normal mode is the same with the light intensity corresponding to the gray level (255) of the flat display 300 in the impulse-driving mode.

In addition to the backlight control unit 348, the timing generator 340 further comprises a first data converter 342, a second data converter 344 and a second selection unit 346. The second selection unit 346 is exemplified by a multiplexer. The first data converter 342 is for converting an input data signal IData as the first data signal. The first data converter 342 substantially converts the input data signal into the first data signal according to a first look-up table (LUT) or a first formula. When the display mode of the flat display 300 is the normal mode, the first selection unit 336 outputs the first set of reference voltages as the reference voltages Vref according to the control signal CS, and the second selection unit 346 outputs the first data signal as the data signal Data to the data driving unit 320 according to the control signal CS. The data driving unit 320 drives the pixels according to the data signal Data and the reference voltages Vref, such that the relationship between the gray level and the light intensity of the pixels is the first gamma curve 201.

The second data converter 344 is for converting input data signal IData into the second data signal. The second data converter 344 substantially converts the input data signal into the second data signal according to a second look-up table or a second formula. When the display mode of the flat display 300 is the impulse-driving mode, the first selection unit 336 outputs the second set of reference voltages as the reference voltages Vref according to the control signal CS, and the second selection unit 346 outputs the second data signal as the data signal Data to the data driving unit 320 according to the control signal CS. The data driving unit 320 drives the pixels according to the data signal Data and the reference voltages Vref, such that the relationship between the gray level and the light intensity of the pixels is a third gamma curve (not illustrated in FIG. 2), and a third normalization curve (not illustrated in FIG. 4) that the third gamma curve is normalized to is close to the first normalization curve 402. Compared with the second normalization curve 406, the third normalization curve is closer to the first normalization curve 402.

Besides, the reference voltage control unit 330 can provide a set of reference voltages Vref for driving the pixels in cooperation with adjusting the input data signal IData by the first data converter 342 and the second data converter 344. When the display mode of the flat display 300 is the normal mode, the reference voltage control unit 330 provides one set of reference voltages Vref, and the second selection unit 346 outputs the first data signal as the data signal Data to the data driving unit 320 according to the control signal CS. The data driving unit 320 drives the pixels according to the data signal Data and the reference voltages Vref, such that the relationship between the gray level and the light intensity of the pixels is the first gamma curve 201.

When the display mode of the flat display 300 is the impulse-driving mode, the reference voltage control unit 330 provides one set of reference voltages Vref, and the second selection unit 346 outputs the second data signal as the data signal Data to the data driving unit 320 according to the control signal CS. The data driving unit 320 drives the pixels according to the data signal Data and the reference voltages Vref, such that the relationship between the gray level and the light intensity of the pixels is a fourth gamma curve (not illustrated in FIG. 2), and a fourth normalization curve (not illustrated in FIG. 4) that the fourth gamma curve is normalized to is close to the first normalization curve 402.

Besides, the second data converter 344 converts the input data signal into the second data signal according to the same principle as in FIG. 5. For example, when input data signal corresponds to the gray level y, and the display mode of the flat display 300 is the normal mode, the data driving unit 320 drives the pixels according to the reference voltage v5′ and the gray level y. When the display mode of the flat display 300 changes as the impulse-driving mode, the data driving unit 320 also changes to drive the pixels according to the reference voltage v5′ and the gray level x. That is, when input data signal corresponds to the gray level x, the second data converter 344 adjusts the input data signal by the deviation of gray level ΔG, such that the input data signal is converted into the second data signal corresponding to the gray level y. According to the above principle, the second data converter 344 converts the input data signal into the second data signal.

If the flat display 300 only needs to be operated in the impulse-driving mode, the reference voltage control unit 330 can only comprise the second reference voltage generator 334 but exclude the first reference voltage generator 332 and the first selection unit 336. The timing controller 340 can only comprise the second data converter 334 and the backlight control unit 348 but exclude the first data converter 342 and the second selection unit 346. The flat display 300 is operated according to the same principle and is not repeated here.

According to the flat display 300 disclosed in above embodiments, the reference voltage control unit 330 provides different reference voltages to the data driving unit 320 for writing data into the pixels, thereby correcting the gamma curve of the flat display 300. In the timing controller 340, the first data converter 342 and the second data converter 344 are substantially for adjusting the input data signal IData. The reference voltage control unit 330 and the data converters 342 and 344 can be used in the above embodiments of the invention separately or together. The reference voltage control unit 330 and the data converters 342 and 344 are both used in the invention mainly for changing the reference voltages received by the data driving unit 320 and secondly for adjusting the input data signal so as to obtain the best display effect.

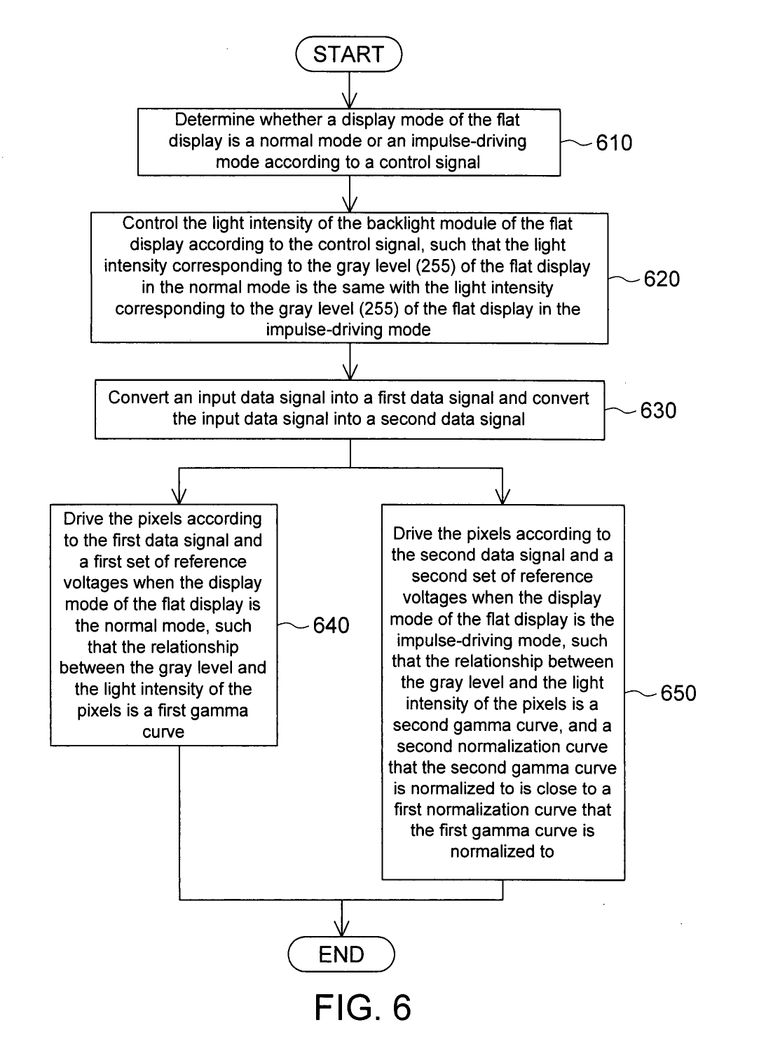

Referring to FIG. 6, a flowchart of a method for driving a flat display according to a preferred embodiment of the invention. The driving method is used in a flat display having multiple pixels. Firstly, the method begins at step 610, whether a display mode of the flat display is a normal mode or an impulse-driving mode is determined according to a control signal. Next, the method proceeds to step 620, the light intensity of the backlight module of the flat display is controlled according to the control signal, such that the light intensity corresponding to the gray level (255) of the flat display in the normal mode is the same with the light intensity corresponding to the gray level (255) of the flat display in the impulse-driving mode.

Next, the method proceeds to step 630, an input data signal is converted into a first data signal, and the input data signal is converted into a second data signal. The step 630 is substantially for adjusting the inputted data. In step 630, the input data signal is converted into the first data signal according to a first look-up table (LUT) or a first formula and the input data signal is converted into the second data signal according to a second look-up table or a second formula, and no specific restriction is imposed.

Afterwards, the method proceeds to step 640, when the display mode of the flat display is the normal mode, the pixels are driven according to the first data signal and a first set of reference voltages, such that the relationship between the gray level and the light intensity of the pixels is a first gamma curve. Besides, in step 650, when the display mode of the flat display is the impulse-driving mode, the pixels are driven according to the second data signal and a second set of reference voltages, such that the relationship between the gray level and the light intensity of the pixels is a second gamma curve, and a second normalization curve that the second gamma curve is normalized to is close to a first normalization curve that the first gamma curve is normalized to.

The flat display and the method for driving the same disclosed in the above embodiments of the invention are used for providing a data driving unit with different reference voltages in different display modes for changing the reference voltages of the pixels when writing data and for adjusting the input data signal according to a look-up table or a formula, such that the distribution curves corresponding to the 256 gray levels of the flat display in different display modes are still similar. Therefore, the color distortion generated in the frame when the flat display is in the impulse-driving mode is repaired, and the light intensities of the middle gray levels are compensated, such that the overall light intensity is improved. By controlling the light intensity of the backlight module, the embodiments of the invention enable the overall light intensity of the pixels of the flat display in the impulse-driving mode to be close to the overall light intensity of the pixels of the flat display in the normal mode.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flat display, comprising:
a pixel array having a plurality of pixels;
a data driving unit for driving the pixels; and
a reference voltage control unit, comprising:
a first reference voltage generator for providing a first set of reference voltages;
a second reference voltage generator for providing a second set of reference voltages; and
a first selection unit for outputting the first set of reference voltages or the second set of reference voltages to the data driving unit according to a control signal;
wherein when the display mode of the flat display is a normal mode, the first selection unit outputs the first set of reference voltages to the data driving unit, and the data driving unit drives the pixels according to a data signal and the first set of reference voltages, such that the relationship between the gray level and the light intensity of the pixels is a first gamma curve;
wherein when the display mode of the flat display is an impulse-driving mode, the first selection unit outputs the second set of reference voltages to the data driving unit, and the data driving unit drives the pixels according to the data signal and the second set of reference voltages, such that the relationship between the gray level and the light intensity of the pixels is a second gamma curve, and a second normalization curve that the second gamma curve is normalized to is close to a first normalization curve that the first gamma curve is normalized to.

2. The flat display according to claim 1, wherein the first set of reference voltages comprises a plurality of first reference voltages corresponding to N gray levels, the second set of reference voltages comprises a plurality of second reference voltages corresponding to N gray levels, and the second reference voltages are obtained by adding corresponding offset voltages to the first reference voltages respectively, N is a positive integer.

3. The flat display according to claim 2, wherein the offset voltages enable the distribution of the second gamma curve to be similar to that of the first gamma curve.

4. The flat display according to claim 3, further comprising a timing generator, wherein the timing generator comprises:
a first data converter for converting an input data signal into a first data signal;
a second data converter for converting the input data signal into a second data signal; and
a second selection unit for outputting the first data signal or the second data signal as the data signal to the data driving unit according to the control signal;
wherein when the display mode of the flat display is the normal mode, the first selection unit outputs the first set of reference voltages to the data driving unit, the second selection unit outputs the first data signal as the data signal to the data driving unit, and the data driving unit drives the pixels according to the data signal and the first set of reference voltages, such that the relationship between the gray level and the light intensity of the pixels is the first gamma curve;
wherein when the display mode of the flat display is the impulse-driving mode, the first selection unit outputs the second set of reference voltages to the data driving unit, the second selection unit outputs the second data signal as the data signal to the data driving unit, and the data driving unit drives the pixels according to the data signal and the second set of reference voltages, such that the relationship between the gray level and the light intensity of the pixels is a third gamma curve, and a third normalization curve that the third gamma curve is normalized to is close to the first normalization curve.

5. The flat display according to claim 4, wherein the first data converter converts the input data signal into the first data signal according to a first look-up table or a first formula.

6. The flat display according to claim 4, wherein the second data converter converts the input data signal into the second data signal according to a second look-up table or a second formula.

7. The flat display according to claim 1, wherein the first reference voltage generator is constituted by a first set of reference resistors or a semi-conductor circuit.

8. The flat display according to claim 1, wherein the second reference voltage generator is constituted by a second set of reference resistors or a semi-conductor circuit.

9. The flat display according to claim 1, further comprises:
a backlight module; and
a backlight control unit for controlling the light intensity of the backlight module.

10. The flat display according to claim 9, wherein the backlight control unit controls the light intensity of the backlight module according to the second gamma curve and the first gamma curve.

11. The flat display according to claim 9, wherein the backlight control unit controls the light intensity of the backlight module, such that the light intensity corresponding to the maximum gray level of the flat display in the normal mode is the same with the light intensity corresponding to the maximum gray level of the flat display in the impulse-driving mode.

12. The flat display according to claim 1, wherein the flat display is a liquid crystal display.

13. A flat display, comprising:
a pixel array having a plurality of pixels;
a data driving unit for driving the pixels; and
a timing generator, comprising:
a first data converter for converting an input data signal into a first data signal;
a second data converter for converting the input data signal into a second data signal; and
a first selection unit for outputting the first data signal or the second data signal to the data driving unit according to a control signal;
wherein when the display mode of the flat display is a normal mode, the first selection unit outputs the first data signal to the data driving unit, and the data driving unit drives the pixels according to the first data signal and a set of reference voltages, such that the relationship between the gray level and the light intensity of the pixels is a first gamma curve;
wherein when the display mode of the flat display is an impulse-driving mode, the first selection unit outputs the second data signal to the data driving unit, and the data driving unit drives the pixels according to the second data signal and the set of reference voltages, such that the relationship between the gray level and the light intensity of the pixels is a second gamma curve, and a second normalization curve that the second gamma curve is normalized to is close to a first normalization curve that the first gamma curve is normalized to.

14. The flat display according to claim 13, wherein the first data converter converts the input data signal into the first data signal according to a first look-up table or a first formula.

15. The flat display according to claim 13, wherein the second data converter converts the input data signal into the second data signal according to a second look-up table or a second formula.

16. The flat display according to claim 13, further comprising a reference voltage control unit, wherein the reference voltage control unit comprises:
a first reference voltage generator for providing a first set of reference voltages;
a second reference voltage generator for providing a second set of reference voltages; and
a second selection unit for outputting the first set of reference voltages or the second set of reference voltages as the set of reference voltages to the data driving unit according to the control signal;
wherein when the display mode of the flat display is the normal mode, the second selection unit outputs the first set of reference voltages as the set of reference voltages to the data driving unit, the first selection unit outputs the first data signal to the data driving unit, and the data driving unit drives the pixels according to the first data signal and the set of reference voltages, such that the relationship between the gray level and the light intensity of the pixels is the first gamma curve;
wherein when the display mode of the flat display is the impulse-driving mode, the second selection unit outputs the second set of reference voltages as the set of reference voltages to the data driving unit, the first selection unit outputs the second data signal to the data driving unit, and the data driving unit drives the pixels according to the second data signal and the set of reference voltages, such that the relationship between the gray level and the light intensity of the pixels is a third gamma curve, and a third normalization curve that the third gamma curve is normalized to is close to the first normalization curve.

17. The flat display according to claim 16, wherein the first set of reference voltages comprises a plurality of first reference voltages corresponding to N gray levels, the second set of reference voltages comprises a plurality of second reference voltages corresponding to N gray levels, and the second reference voltages are obtained by adding corresponding offset voltages to the first reference voltages respectively, N is a positive integer.

18. The flat display according to claim 17, wherein the offset voltages enable the distribution of the third gamma curve to be similar to that of the first gamma curve.

19. The flat display according to claim 16, wherein the first reference voltage generator is constituted by a first set of reference resistors or a semi-conductor circuit.

20. The flat display according to claim 16, wherein the second reference voltage generator is constituted by a second set of reference resistors or a semi-conductor circuit.

21. The flat display according to claim 16, further comprises:
a backlight module; and
a backlight control unit for controlling the light intensity of the backlight module.

22. The flat display according to claim 21, wherein the backlight control unit controls the light intensity of the backlight module according to the third gamma curve and the first gamma curve.

23. The flat display according to claim 21, wherein the backlight control unit controls the light intensity of the backlight module, such that the light intensity corresponding to the maximum gray level of the flat display in the normal mode is the same with the light intensity corresponding to the maximum gray level of the flat display in the impulse-driving mode.

24. The flat display according to claim 13, wherein the flat display is a liquid crystal display.

25. A method for driving a flat display having multiple pixels, comprising:
determining whether a display mode of the flat display is a normal mode or an impulse-driving mode according to a control signal;
driving the pixels according to a data signal and a first set of reference voltages when the display mode of the flat display is the normal mode such that the relationship between the gray level and the light intensity of the pixels is a first gamma curve; and
driving the pixels according to the data signal and a second set of reference voltages when the display mode of the flat display is the impulse-driving mode, such that the relationship between the gray level and the light intensity of the pixels is a second gamma curve, and a second normalization curve that the second gamma curve is normalized to is close to a first normalization curve that the first gamma curve is normalized to.

26. The method for driving a flat display according to claim 25, wherein the first set of reference voltages comprises a plurality of first reference voltages corresponding to N gray levels, the second set of reference voltages comprises a plurality of second reference voltages corresponding to N gray levels, and the second reference voltages are obtained by adding corresponding offset voltages to the first reference voltages respectively, N is a positive integer.

27. The method for driving a flat display according to claim 26, wherein the offset voltages enable the distribution of the second gamma curve to be similar to that of the first gamma curve.

28. The method for driving a flat display according to claim 25, further comprises:
converting an input data signal into a first data signal;
converting the input data signal into a second data signal;
driving the pixels according to the first data signal and the first set of reference voltages when the display mode of the flat display is the normal mode, such that the relationship between the gray level and the light intensity of the pixels is the first gamma curve; and
driving the pixels according to the second data signal and the second set of reference voltages when the display mode of the flat display is the impulse-driving mode, such that the relationship between the gray level and the light intensity of the pixels is a third gamma curve, and a third normalization curve that the third gamma curve is normalized to is close to the first normalization curve.

29. The method for driving a flat display according to claim 28, wherein the input data signal is converted into the first data signal according to a first look-up table or a first formula.

30. The method for driving a flat display according to claim 28, wherein the input data signal is converted into the second data signal according to a second look-up table or a second formula.

31. The method for driving a flat display according to claim 25, wherein the flat display further comprises a backlight module, and the method further comprises:
controlling the light intensity of the backlight module according to the control signal, such that the light intensity corresponding to the maximum gray level of the flat display in the normal mode is the same with the light intensity corresponding to the maximum gray level of the flat display in the impulse-driving mode.

32. A method for driving a flat display having multiple pixels, comprising:
determining whether a display mode of the flat display is a normal mode or an impulse-driving mode according to a control signal;
converting an input data signal into a first data signal;
converting the input data signal into a second data signal;
driving the pixels according to the first data signal and a set of reference voltages when the display mode of the flat display is the normal mode, such that the relationship between the gray level and the light intensity of the pixels is a first gamma curve; and
driving the pixels according to the second data signal and the set of reference voltages when the display mode of the flat display is the impulse-driving mode, such that the relationship between the gray level and the light intensity of the pixels is a second gamma curve, and a second normalization curve that the second gamma curve is normalized to is close to a first normalization curve that the first gamma curve is normalized to.

33. The method for driving a flat display according to claim 32, wherein the input data signal is converted into the first data signal according to a first look-up table or a first formula.

34. The method for driving a flat display according to claim 32, wherein the input data signal is converted into the second data signal according to a second look-up table or a second formula.

35. The method for driving a flat display according to claim 32, further comprises:
driving the pixels according to the first data signal and a first set of reference voltages when the display mode of the flat display is the normal mode, such that the relationship between the gray level and the light intensity of the pixels is the first gamma curve; and
driving the pixels according to the second data signal and a second set of reference voltages when the display mode of the flat display is the impulse-driving mode, such that the relationship between the gray level and the light intensity of the pixels is a third gamma curve, and a third normalization curve that the third gamma curve is normalized to is close to the first normalization curve.

36. The method for driving a flat display according to claim 35, wherein the first set of reference voltages comprises a plurality of first reference voltages corresponding to N gray levels, the second set of reference voltages comprises a plurality of second reference voltages corresponding to N gray levels, and the second reference voltages are obtained by adding corresponding offset voltages to the first reference voltages respectively, N is a positive integer.

37. The method for driving a flat display according to claim 36, wherein the offset voltages enable the distribution of the third gamma curve to be similar to that of the first gamma curve.

38. The method for driving a flat display according to claim 35, wherein the flat display further comprises a backlight module, and the method further comprises:
controlling the light intensity of the backlight module according to the control signal, such that the light intensity corresponding to the maximum gray level of the flat display in the normal mode is the same with the light intensity corresponding to the maximum gray level of the flat display in the impulse-driving mode.

39. A flat display, comprising:
a pixel array having a plurality of pixels;
a data driving unit for driving the pixels; and
an impulse-driving reference voltage generator for providing a set of impulse-driving reference voltages;
wherein when the display mode of the flat display is an impulse-driving mode, the data driving unit drives the pixels according to an impulse-driving data signal and the set of impulse-driving reference voltages, such that the relationship between the gray level and the light intensity of the pixels is a first gamma curve, and a first normalization curve that the first gamma curve is normalized to is close to a target normalization curve that a target gamma curve is normalized to.

40. The flat display according to claim 39, wherein the set of impulse-driving reference voltages comprises a plurality of impulse-driving reference voltages corresponding to N gray levels, N is a positive integer.

41. The flat display according to claim 40, wherein the distribution of the first gamma curve is similar to that of the target gamma curve.

42. The flat display according to claim 41, further comprising a timing generator, wherein the timing generator comprises:
an impulse-driving data converter for converting an input data signal into the impulse-driving data signal.

43. The flat display according to claim 42, wherein the impulse-driving data converter converts the input data signal into the impulse-driving data signal according to a look-up table or a formula.

44. The flat display according to claim 39, wherein the impulse-driving reference voltage generator is constituted by a set of impulse-driving reference resistors or a semi-conductor circuit.

45. The flat display according to claim 39, further comprising:
a backlight module; and
a backlight control unit for controlling the light intensity of the backlight module.

46. The flat display according to claim 45, wherein the backlight control unit controls the light intensity of the backlight module according to the target gamma curve and the first gamma curve.

47. The flat display according to claim 39, wherein the flat display is a liquid crystal display.

48. A flat display, comprising:
a pixel array having a plurality of pixels;
a data driving unit for driving the pixels; and
a timing generator, comprising:
an impulse-driving data converter for converting an input data signal into an impulse-driving data signal;
wherein when the display mode of the flat display is an impulse-driving mode, the timing generator outputs the impulse-driving data signal to the data driving unit, and the data driving unit drives the pixels according to the impulse-driving data signal and a set of impulse-driving reference voltages, such that the relationship between the gray level and the light intensity of the pixels is a first gamma curve, and a first normalization curve that the first gamma curve is normalized to is close to a target normalization curve that a target gamma curve is normalized to.

49. The flat display according to claim 48, wherein the impulse-driving data converter converts the input data signal into the impulse-driving data signal according to a look-up table or a formula.

50. The flat display according to claim 48, further comprising:
an impulse-driving reference voltage generator for providing the set of impulse-driving reference voltages.

51. The flat display according to claim 50, wherein the set of impulse-driving reference voltages comprises a plurality of impulse-driving reference voltage corresponding to N gray levels, N is a positive integer.

52. The flat display according to claim 51, wherein the distribution of the first gamma curve is similar to that of the target gamma curve.

53. The flat display according to claim 52, wherein the impulse-driving reference voltage generator is constituted by a set of impulse-driving reference resistors or a semi-conductor circuit.

54. The flat display according to claim 50, further comprises:
a backlight module; and
a backlight control unit for controlling the light intensity of the backlight module.

55. The flat display according to claim 54, wherein the backlight control unit controls the light intensity of the backlight module according to the target gamma curve and the first gamma curve.

56. The flat display according to claim 48, wherein the flat display is a liquid crystal display.
